(19) United States
(12) Patent Application Publication
(10) Pub. No.: US 2025/0305267 A1
(43) Pub. Date: Oct. 2, 2025

(54) FLUSH TOILET APPARATUS

(71) Applicant: TOTO LTD., Kitakyushu-shi (JP)

(72) Inventors: Yu YAMASAKI, Kitakyushu-shi (JP); Seiya NAKASHIMA, Kitakyushu-shi (JP); Yamato NAKANO, Kitakyushu-shi (JP); Hiroshi HASHIMOTO, Kitakyushu-shi (JP); Kenichi NAKAMURA, Kitakyushu-shi (JP)

(73) Assignee: TOTO LTD., Kitakyushu-shi (JP)

(21) Appl. No.: 19/086,629

(22) Filed: Mar. 21, 2025

(30) Foreign Application Priority Data
Mar. 29, 2024 (JP) 2024-056238

(51) Int. Cl. E03D 11/13; E03D 1/26; E03D 1/34

(52) U.S. Cl. CPC E03D 11/13; E03D 1/266; E03D 1/34

(57) ABSTRACT

The present invention provides a flush toilet apparatus (1) including a flush toilet main body (2) including a bowl (2a) and a discharge trap conduit (2b), a flush water tank main body (4), a rim discharge valve (8) that controls spouting and stop of flush water from a rim spout port (2c), a jet discharge valve (10) that controls spouting and stop of flush water from a jet spout port (2d), a rim conduit (2e) that guides flush water drained via the rim discharge valve to the rim spout port, and a jet conduit (2f) that guides flush water drained via the jet discharge valve to the jet spout port, and a cross-sectional area of the rim spout port is smaller than a cross-sectional area of the jet spout port.

### BACKGROUND OF THE INVENTION

### Field of the Invention

The present invention relates to a flush toilet apparatus, particularly to a flush toilet apparatus which performs flushing with flush water stored in a flush water tank.

### Description of the Related Art

In Japanese Patent Laid-Open No. 2015-168994 (Patent Literature 1), a flush toilet is described. In this flush toilet, a discharge valve provided in a storage tank device is opened, to spout flush water from two rim spout ports and a jet spout port provided in the flush toilet, thereby flushing a bowl. In this flush toilet, flush water drained from the storage tank device first flows into a single water conduit. This water conduit is branched to spout flush water from two rim spout ports and the jet spout port.

In the flush toilet described in Patent Literature 1, an instantaneous flow rate of flush water spouted from two rim spout ports and the jet spout port transitions as shown in FIG. 8, and flush water stored in the storage tank device cannot be fully utilized in toilet flushing. FIG. 8 is a graph showing, as a comparative example, an example of the instantaneous flow rate of flush water in such a flush toilet as described in Patent Literature 1 in which flush water flowing into the single water conduit is branched to be spouted from the rim spout ports and the jet spout port.

That is, in such a type of flush toilet, flush water is spouted from the jet spout port at a large flow rate immediately after the discharge valve is opened, and then the instantaneous flow rate of flush water spouted from the two rim spout ports gradually rises. Then, once the discharge valve is closed, the flush water spouted from the two rim spout ports is immediately stopped, while spouting from the jet spout port continuously for a predetermined time even after the valve is closed. This is because the rim spout ports are at a high position, so that the spouting is stopped immediately after the discharge valve is closed, whereas the jet spout port is at a low position, so that flush water remaining in the water conduit is spouted even after the discharge valve is closed. Thus, in the flush toilet described in Patent Literature 1, time for which rim spouting is continued is short, and there is a possibility that a bowl surface cannot be sufficiently flushed. In addition, if time for rim spouting is tried to be extended to sufficiently flush the bowl surface, an entire amount of flush water increases significantly, and water saving cannot be achieved.

Therefore, the present invention has an object to provide a flush toilet apparatus capable of achieving water saving while securing sufficient rim spouting time by use of flush water stored in a flush water tank.

### SUMMARY OF THE INVENTION

To solve the above-described problems, the present invention provides a flush toilet apparatus that flushes with flush water stored in a flush water tank, including: a flush toilet main body including a bowl and a discharge trap conduit extending from a lower part of the bowl, a flush water tank main body that stores flush water for flushing the bowl of the flush toilet main body, a rim discharge valve provided in the flush water tank main body, to control spouting and stop of flush water from one or more rim spout ports provided in the flush toilet main body, a jet discharge valve provided in the flush water tank main body, to control spouting and stop of flush water from a jet spout port provided in the flush toilet main body, a rim conduit provided in the flush toilet main body, to guide flush water drained via the rim discharge valve to the one or more rim spout ports, and a jet water conduit provided in the flush toilet main body, to guide flush water drained via the jet discharge valve to the jet spout port, and a sum of cross-sectional areas of the one or more rim spout ports is smaller than a cross-sectional area of the jet spout port.

According to the present invention including this configuration, the flush water in the flush water tank main body is spouted from the rim spout port via the rim discharge valve and the rim conduit, and the flush water is spouted from the jet spout port via the jet discharge valve and a jet conduit. Consequently, an amount of flush water spouted from the rim spout port and an amount of flush water spouted from the jet spout port can be independently controlled, and the amount of rim spouting can be sufficiently secured. Thus, the bowl can be sufficiently flushed. Furthermore, the sum of the cross-sectional areas of the rim spout ports is smaller than the cross-sectional area of the jet spout port. Therefore, even if spouting time from the rim spout port is sufficiently secured, an amount of flush water for use does not increase significantly, and water saving can be achieved.

In the present invention, preferably, the rim conduit is configured so that the one or more rim spout ports are each at the lowest position in a path from the rim discharge valve to the one or more rim spout ports.

According to the present invention including this configuration, the rim conduit is configured so that the one or more rim spout ports are each at the lowest position in the path from the rim discharge valve to the one or more rim spout ports. Therefore, the flush water drained via the rim discharge valve is spouted from the rim spout port without detouring. As a result, an instantaneous flow rate of the flush water spouted from the rim spout port rises in a short time, and a sufficient flushing effect can be obtained even if the spouting time is reduced.

In the present invention, preferably, the jet discharge valve is opened with elapse of a predetermined time after the rim discharge valve is opened, and the spouting of flush water from the one or more rim spout ports is continued even after the jet discharge valve is closed.

According to the present invention including this configuration, the jet discharge valve is opened with the elapse of the predetermined time after the rim discharge valve is opened. Therefore, after flushing the bowl by rim spouting, siphon action is activated by jet spouting, and hence flush water can be efficiently distributed to flush a bowl surface and to discharge waste. In addition, since the spouting of flush water from the rim spout port is continued even after the jet discharge valve is closed, water spouted from the rim spout port can be utilized to refill the bowl.

In the present invention, preferably, an instantaneous flow rate of the flush water spouted from the one or more rim spout ports is largest at start of spouting and then gradually decreases.

According to the present invention including this configuration, the instantaneous flow rate of the flush water spouted from the rim spout port is largest at the start of the spouting and then gradually decreases, and hence the instantaneous flow rate of the flush water from the rim spout port decreases after the siphon action is activated by the jet spouting. Consequently, siphon breaks after waste is drained by the siphon action is accelerated, and wasteful drain of the flush water into the discharge trap conduit can be suppressed. Thus, the flush water can be efficiently utilized.

In the present invention, preferably, the flush toilet main body includes single rim spout port.

According to the present invention including this configuration, since the flush toilet main body includes one rim spout port, the total cross-sectional area of the rim spout port can be easily set small, and the spouting time of flush water from the rim spout port can be extended while reducing an amount of flush water for use.

In the present invention, preferably, the rim discharge valve is located outside the jet discharge valve in a width direction of the flush toilet main body, and the rim conduit extends, to the rim spout port, through outside a seat hole provided on an upper surface of the flush toilet main body in the width direction of the flush toilet main body.

According to the present invention including this configuration, the rim discharge valve is located outside the jet discharge valve in the width direction of the flush toilet main body, and the rim conduit extends, to the rim spout port, through outside the seat hole provided on the upper surface of the flush toilet main body in the width direction of the flush toilet main body. As a result, while securing a sufficient space for the jet conduit in the flush toilet main body, the rim conduit that communicates between the rim discharge valve and the rim spout port can be formed short, and rim spouting can be started at an early stage.

According to the flush toilet apparatus of the present invention, water saving can be achieved while securing sufficient time for rim spouting by use of flush water stored in the flush water tank.

### BRIEF DESCRIPTION OF THE DRAWINGS

FIG. 1 is a top view showing a schematic configuration of a flush toilet apparatus according to an embodiment of the present invention;

FIG. 2 is a side cross-sectional view showing the schematic configuration of the flush toilet apparatus according to the embodiment of the present invention;

FIG. 3 is a cross-sectional view of a rim conduit in a flush toilet main body of the flush toilet apparatus according to the embodiment of the present invention cut along the rim conduit;

FIG. 4 is a block diagram showing a flush water supply system in the flush toilet apparatus according to the embodiment of the present invention;

FIG. 5 is a front cross-sectional view showing an internal configuration of a main body of a flush water tank provided in the flush toilet apparatus according to the embodiment of the present invention;

FIG. 6 is a time chart showing an operation of the flush toilet apparatus according to the embodiment of the present invention;

FIG. 7 is a diagram showing an example of an instantaneous flow rate of flush water spouted from each of a rim spout port and a jet spout port in the flush toilet apparatus of the present embodiment; and

FIG. 8 is a graph showing, as a comparative example, an example of the instantaneous flow rate of flush water in a type of flush toilet in which flush water flowing into a single water conduit is branched to be spouted from a rim spout port and a jet spout port.

### DETAILED DESCRIPTION OF THE INVENTION

Next, with reference to the accompanying drawings, a flush toilet apparatus according to an embodiment of the present invention will be described.

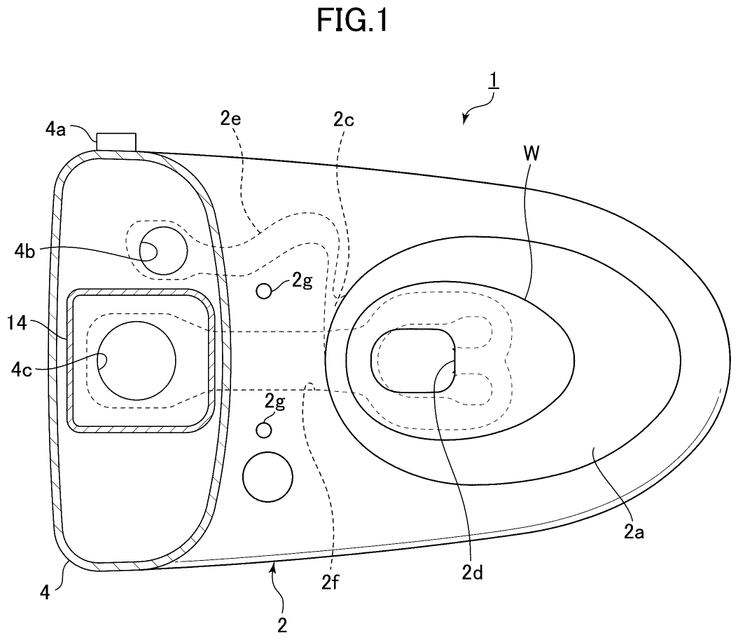

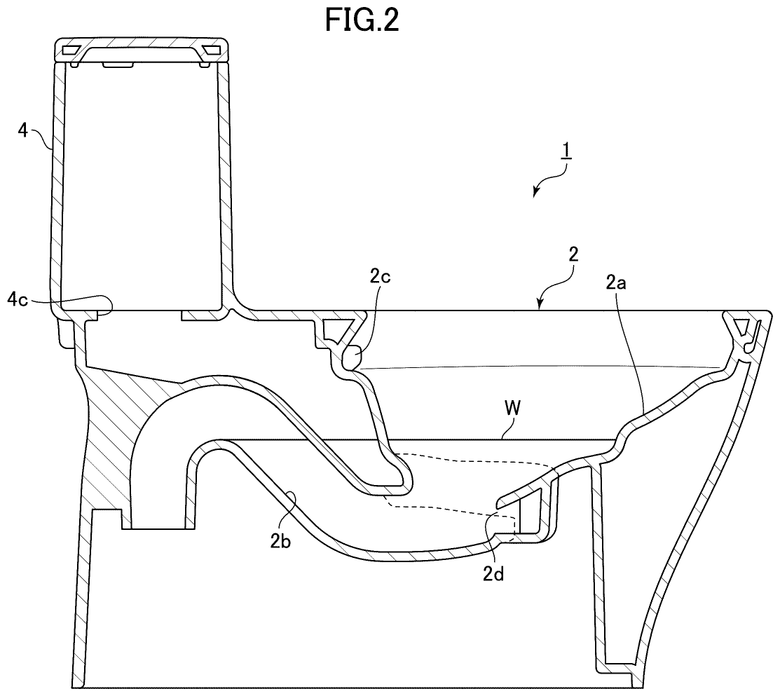

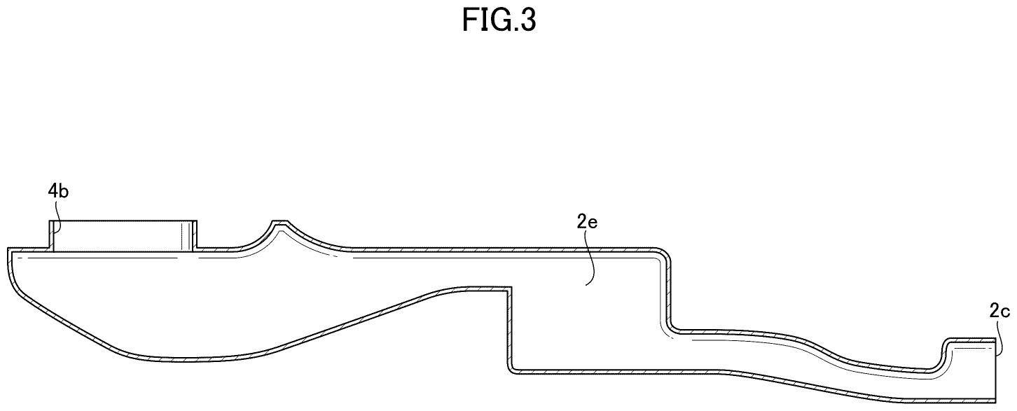

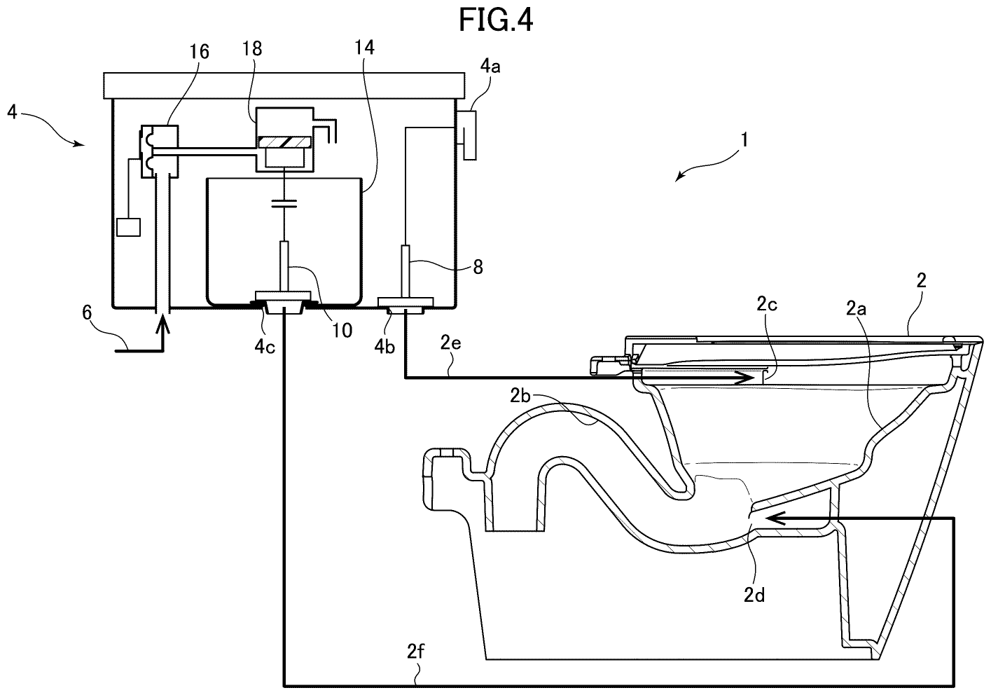

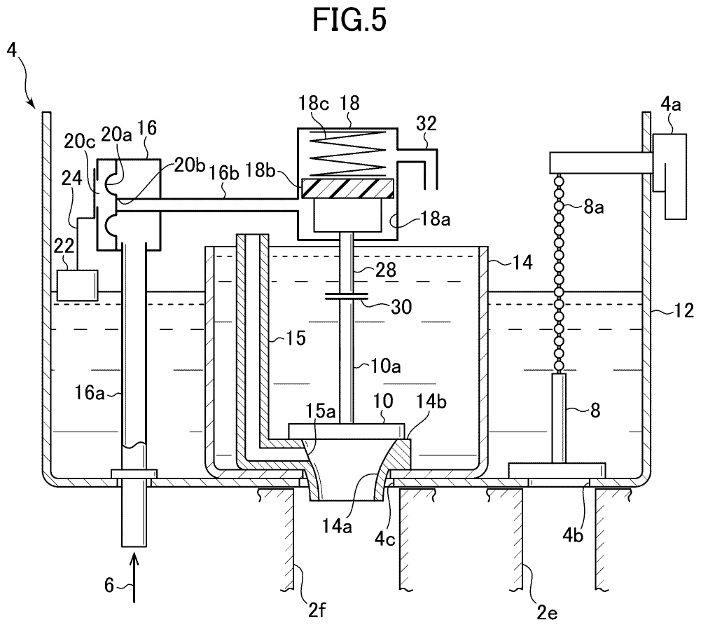

FIG. 1 is a top view showing a schematic configuration of a flush toilet apparatus according to an embodiment of the present invention. FIG. 2 is a side cross-sectional view showing the schematic configuration of the flush toilet apparatus according to the embodiment of the present invention. FIG. 3 is a cross-sectional view of a rim conduit in a flush toilet main body of the flush toilet apparatus according to the embodiment of the present invention cut along the rim conduit. FIG. 4 is a block diagram showing a flush water supply system in the flush toilet apparatus according to the embodiment of the present invention. FIG. 5 is a front cross-sectional view showing an internal configuration of a main body of a flush water tank provided in the flush toilet apparatus according to the embodiment of the present invention.

As shown in FIGS. 1 and 2, a flush toilet apparatus 1 according to the embodiment of the present invention includes a flush toilet main body 2 and a flush water tank main body 4 disposed at the rear of the flush toilet main body 2. The flush toilet apparatus 1 of the present embodiment is configured to be flushed by operating a lever handle 4a provided to the flush water tank main body 4 after use. In FIGS. 1 and 2, a discharge valve and the like provided in the flush water tank main body 4 are not shown.

The flush toilet main body 2 includes a bowl 2a and a discharge trap conduit 2b extending from a lower part of the bowl 2a. Furthermore, a rim spout port 2c is provided in a top edge portion of the bowl 2a, and a jet spout port 2d is provided in the lower part of the bowl 2a. During toilet flushing, flush water is spouted from each of the rim spout port 2c and the jet spout port 2d at a predetermined timing, and a waste receiving surface of the bowl 2a is flushed, while waste and flush water in the bowl 2a are drained to the discharge trap conduit 2b. The waste and flush water drained to the discharge trap conduit 2b are drained through a discharge socket (not shown) to a sewage pipe (not shown).

Furthermore, two seat holes 2g are provided on the upper surface of the flush toilet main body 2 at the rear of the bowl 2a and in front of the flush water tank main body 4. The seat holes 2g have a circular cross-sectional shape, are provided for fixing a toilet seat (not shown) to the upper surface of the flush toilet main body 2 and are provided symmetrically on opposite sides of a centerline of the flush toilet main body 2 in a width direction.

As shown in FIG. 4, flush water is supplied to the flush water tank main body 4 from a water supply source 6 such as a water supply, and the supplied flush water is stored in the flush water tank main body 4. Furthermore, in the flush water tank main body 4, a built-in rim discharge valve 8 and a built-in jet discharge valve 10 are configured to spout and stop flush water from a drain port provided in a bottom portion of the flush water tank main body 4.

In the present embodiment, by opening the rim discharge valve 8, flush water is drained from a rim spouting drain port 4b (FIG. 1) of the flush water tank main body 4 and spouted from the rim spout port 2c through a rim conduit 2e formed inside the flush toilet main body 2. Furthermore, by opening the jet discharge valve 10, flush water is drained from a jet spouting drain port 4c (FIG. 1) of the flush water tank main body 4 and spouted from the jet spout port 2d through a jet conduit 2f formed inside the flush toilet main body 2.

As shown in FIGS. 1 and 2, the jet spouting drain port 4c is provided in the center of the flush toilet main body 2 in the width direction. The jet conduit 2f connected to the jet spouting drain port 4c extends diagonally downward and forward in the flush toilet main body 2 and then divides into two parts to pass through opposite sides of a well portion in a bottom portion of the bowl 2a. Furthermore, the parts are again joined in front of the well portion and connected to the jet spout port 2d.

As shown in FIG. 1, the rim spouting drain port 4b is located outside the jet spouting drain port 4c in the width direction of the flush toilet main body 2, and the rim discharge valve 8 and the jet discharge valve 10 are arranged directly above the rim spouting drain port 4b and the jet spouting drain port 4c, respectively. Therefore, the rim discharge valve 8 is located outside the jet discharge valve 10 in the width direction of the flush toilet main body 2. The rim conduit 2e extending from the rim spouting drain port 4b extends, to the rim spout port 2c, through outside the seat holes 2g provided on the upper surface of the flush toilet main body 2 in the width direction of the flush toilet main body.

Furthermore, in the present embodiment, the rim conduit 2e has a cross-sectional shape shown in FIG. 3. FIG. 3 is a view showing a cross section of the rim conduit 2e cut along a length direction of the rim conduit. As shown in FIG. 3, the rim conduit 2e extends to the rim spout port 2c from the rim spouting drain port 4b opened upward. The rim conduit 2e is configured so that the rim spout port 2c is at the lowest position in a path from the rim discharge valve 8 to the rim spout port 2c. In other words, as shown in FIG. 3, a bottom surface in the rim spout port 2c is lowest in a bottom surface of the rim conduit 2e. Consequently, the flush water drained via the rim discharge valve 8 is spouted from the rim spout port 2c without detouring. As a result, an instantaneous flow rate of the flush water spouted from the rim spout port 2c rises in a short time, and a sufficient flushing effect can be obtained even if spouting time is reduced.

In the present embodiment, one rim spout port 2c is provided near the center of the rear of the bowl 2a in the width direction. In the present embodiment, the rim spout port 2c is configured to have a cross-sectional area that is smaller than a cross-sectional area of the jet spout port 2d. When a plurality of rim spout ports 2c are provided, the rim spout ports are preferably configured so that a sum of cross-sectional areas of the respective rim spout ports 2c is smaller than a cross-sectional area of the jet spout port 2d. Furthermore, when the plurality of rim spout ports 2c are provided, the rim spout ports are preferably configured so that bottom surfaces of the respective rim spout ports 2c are arranged at the same height and so that the height of the bottom surface is lowest in the path of the rim conduit 2e that extends from the rim discharge valve 8 to the rim spout port 2c.

Next, with reference to FIGS. 4 and 5, an internal structure of the flush water tank main body 4 will be described.

As shown in FIGS. 4 and 5, an inner tank 14 is disposed inside the flush water tank main body 4. Inside the flush water tank main body 4, the rim discharge valve 8 disposed outside the inner tank 14 in the flush water tank main body 4, the jet discharge valve 10 disposed in the inner tank 14, a ball tap 16 that is a water supply valve, and a hydraulic drive mechanism 18 are provided.

The flush water tank main body 4 and the inner tank 14 are containers configured to store flush water to be supplied to the flush toilet main body 2. In the present embodiment, the flush water tank main body 4 is made of ceramic, and the inner tank 14 disposed inside the flush water tank main body 4 is made of resin. In the present specification, “flush water stored in the flush water tank main body 4” includes flush water stored in the inner tank 14 in addition to flush water stored inside the flush water tank main body 4 (outside the inner tank 14).

Furthermore, as shown in FIGS. 1 and 5, the rim spouting drain port 4b and the jet spouting drain port 4c are provided on a bottom surface of the flush water tank main body 4, and in the present embodiment, these drain ports are formed in a circular shape. As shown in FIG. 2, in the present embodiment, the rim spouting drain port 4b and the jet spouting drain port 4c (FIG. 2 only shows the jet spouting drain port 4c) are formed at the same height as an upper end surface of the bowl 2a, while the rim spout port 2c is formed below the upper end surface of the bowl 2a. Therefore, in the present embodiment, the rim spouting drain port 4b and the jet spouting drain port 4c are each provided at a position higher than a lower end of the rim spout port 2c.

In the present embodiment, the flush water stored inside the flush water tank main body 4 (and outside the inner tank 14) flows through the rim spouting drain port 4b into the rim conduit 2e of the flush toilet main body 2, and the flush water stored in the inner tank 14 flows through the jet spouting drain port 4c into the jet conduit 2f of the flush toilet main body 2. Alternatively, the inner tank 14 may be omitted, and in this case, flush water stored in a space (undivided) in the flush water tank main body 4 is supplied through the rim spouting drain port 4b and the jet spouting drain port 4c to the flush toilet main body 2.

As shown in FIG. 5, the inner tank 14 is disposed on the bottom surface of the flush water tank main body 4, and a circular drain port 14a is formed on the bottom surface of the inner tank 14. The drain port 14a of the inner tank 14 is disposed concentrically with the jet spouting drain port 4c provided in the flush water tank main body 4. That is, in the present embodiment, the center of the circular jet spouting drain port 4c and the circular drain port 14a coincide in top view. Therefore, the flush water in the inner tank 14 is spouted through the drain port 14a of the inner tank 14 and the jet spouting drain port 4c of the flush water tank main body 4 and flows into the jet conduit 2f of the flush toilet main body 2.

Furthermore, in the present embodiment, the drain port 14a of the inner tank 14 is composed of a drain port forming member 14b composed separately from a main body portion of the inner tank 14. The drain port forming member 14b is a tubular member and is water-tightly attached to the bottom surface of the inner tank 14 to form the drain port 14a inside. Furthermore, a seat surface is provided on an upper end of the drain port forming member 14b, and the drain port 14a is closed by the jet discharge valve 10 seated on the seat surface. Therefore, in the present embodiment, the seat surface on which the jet discharge valve 10 is seated is composed of a member separate from the inner tank 14.

Furthermore, an overflow pipe 15 that is an exhaust path is attached to a side surface of the drain port forming member 14b. The overflow pipe 15 is an L-shaped bent pipe, extends from the side surface of the drain port forming member 14b, and is opened upward above an upper end of the inner tank 14. Consequently, a space inside the drain port forming member 14b communicates with outside air above a water surface of the inner tank 14 through the overflow pipe 15. For the overflow pipe 15, if a water level of the flush water in the flush water tank main body 4 exceeds a height of the overflow pipe 15, the flush water flows into the overflow pipe 15 and is drained through the drain port forming member 14b to the jet conduit 2f.

Next, as shown in FIG. 5, the rim discharge valve 8 is a valve body disposed to open and close the rim spouting drain port 4b provided in the flush water tank main body 4, and the rim spouting drain port 4b is opened by pulling the rim discharge valve 8 upward. Consequently, the flush water in the flush water tank main body 4 is drained to the rim conduit 2e (FIG. 1) of the flush toilet main body 2 and spouted from the rim spout port 2c. Therefore, the rim discharge valve 8 is provided in the flush water tank main body 4, to control spouting and stop of flush water from the rim spout port 2c provided in the flush toilet main body 2.

In the present embodiment, a bead chain 8a (FIG. 5) coupled to the rim discharge valve 8 is pulled by a user rotating and operating the lever handle 4a provided to the flush water tank main body 4, and the rim discharge valve 8 is pulled upward. As a modification, the present invention may include a configuration in which the rim discharge valve 8 is pulled up based on a control signal from a remote controller (not shown) or a detection signal from a human sensor (not shown), to perform flushing.

The jet discharge valve 10 is a valve body provided in the jet spouting drain port 4c of the flush water tank main body 4 and disposed to open and close the drain port 14a provided in the inner tank 14. The jet discharge valve 10 is pulled upward, and the jet discharge valve 10 is then unseated from the seat surface of the drain port 14a, to open the drain port 14a. Consequently, the flush water in the inner tank 14 flows through the drain port 14a and the jet spouting drain port 4c of the flush water tank main body 4 into the jet conduit 2f (FIG. 1).

Thus, the jet discharge valve 10 is pulled up, and the flush water in the inner tank 14 is drained from the drain port 14a, flows through the jet spouting drain port 4c into the jet conduit 2f (FIG. 1) of the flush toilet main body 2 and is spouted from the jet spout port 2d. Therefore, the jet discharge valve 10 is provided in the flush water tank main body 4 to control the spouting and stop of the flush water from the jet spout port 2d provided in the flush toilet main body 2. Alternatively, the inner tank 14 may be omitted, and in this case, the jet spouting drain port 4c is directly opened and closed by the jet discharge valve 10, to drain the flush water inside the flush water tank main body 4.

As shown in FIG. 5, in the present embodiment, the jet discharge valve 10 is configured to be pulled up from the drain port 14a by the hydraulic drive mechanism 18. That is, the jet discharge valve 10 is a valve body including a valve shaft 10a extending upward, and the valve shaft 10a is pulled up by the hydraulic drive mechanism 18. Then, the jet discharge valve 10, pulled up to a predetermined height, is disconnected from the hydraulic drive mechanism 18 and gently descends to close the drain port 14a. The configuration of the hydraulic drive mechanism 18 will be described later.

Furthermore, the ball tap 16 that is the water supply valve, includes an inflow pipe 16a through which flush water supplied from the water supply source 6 flows into the ball tap, and is configured to switch supply and stop of flush water to be stored in the flush water tank main body 4 and the inner tank 14.

As shown in FIG. 5, in the ball tap 16 to which the inflow pipe 16a and an outflow pipe 16b are connected, a valve seat 20b is opened and closed by a built-in main valve body 20a. The ball tap 16 also includes a float 22 and an arm 24 rotated by the float 22. The float 22 provided in the ball tap 16 operates in conjunction with a water level in the flush water tank main body 4, and the float 22 lowers to a predetermined position to open the built-in main valve body 20a, thereby supplying flush water to the hydraulic drive mechanism 18.

Specifically, inside the ball tap 16, the main valve body 20a is disposed to open and close the valve seat 20b and is configured so that when the valve body is opened, tap water inflowing from the inflow pipe 16a flows through the valve seat 20b, to flow out to the outflow pipe 16b. The outflow pipe 16b is then connected to the hydraulic drive mechanism 18.

The main valve body 20a is a diaphragm valve body that is generally disc-shaped and is attached into the ball tap 16 to be seated on and unseated from the valve seat 20b. Furthermore, in the ball tap 16, a pressure chamber 20c is formed on a side of the main valve body 20a opposite to the valve seat 20b. To communicate with an interior of the pressure chamber 20c, the ball tap 16 includes a pilot valve port (not shown). When the pilot valve port (not shown) is closed to increase pressure in the pressure chamber 20c, the main valve body 20a is pushed against the valve seat 20b by the pressure and seated on the valve seat 20b.

On one hand, the float 22 is supported by the arm 24, and the arm 24 is coupled to a pilot valve (not shown). The pilot valve is configured to move together with the rotation of the arm 24. In the present embodiment, the float 22 is disposed in the flush water tank main body 4 and moved vertically depending on the water level in the flush water tank main body 4. Consequently, when the water level in the flush water tank main body 4 is raised to or above a predetermined water level, the float 22 is pushed upward, and the pilot valve (not shown) is accordingly moved, to close the pilot valve port (not shown) provided in the ball tap 16. On the other hand, when the flush water in the flush water tank main body 4 is discharged to lower the water level, the float 22 moves downward, to open the pilot valve port (not shown). Therefore, when toilet flushing is on standby in a state in which the water level in the flush water tank main body 4 is higher than the predetermined water level, the pilot valve port (not shown) of the ball tap 16 is closed.

Furthermore, tap water flowing through the inflow pipe 16a into the ball tap 16 flows into the pressure chamber 20c. In the state in which the pilot valve port (not shown) is closed, the pressure in the pressure chamber 20c increases. If the pressure in the pressure chamber 20c increases in this way, the main valve body 20a is pressed toward the valve seat 20b by this pressure, and the valve seat 20b is closed by the main valve body 20a.

In contrast, when the rim discharge valve 8 is opened by a flushing operation and the water level in the flush water tank main body 4 becomes lower than the predetermined water level, the float 22 descends, and the pilot valve (not shown) moves, to open the pilot valve port (not shown). By opening the pilot valve port (not shown), the pressure in the pressure chamber 20c is decreased. Consequently, the main valve body 20a is moved to be pulled away from the valve seat 20b, to open the valve seat 20b. Consequently, in the state in which the pilot valve port (not shown) is opened, the pressure in the pressure chamber 20c does not increase, to open the valve seat 20b.

Next, with reference to FIG. 5, the configuration of the hydraulic drive mechanism 18 will be described.

The hydraulic drive mechanism 18 is configured to drive the jet discharge valve 10 using a water supply pressure of the flush water supplied from the water supply to the flush water tank main body 4. Specifically, the hydraulic drive mechanism 18 includes a cylinder 18a into which water supplied from the ball tap 16 flows, a piston 18b slidably disposed in the cylinder 18a, and a rod 28 that protrudes from a lower end of the cylinder 18a to drive the jet discharge valve 10. Furthermore, a spring 18c is disposed inside the cylinder 18a, to bias the piston 18b downward, and a packing is attached to the piston 18b, to secure watertightness between an inner wall surface of the cylinder 18a and the piston 18b. In addition, a clutch mechanism 30 is provided at a lower end of the rod 28, and the rod 28 and the valve shaft 10a of the jet discharge valve 10 are coupled/decoupled by the clutch mechanism 30.

The cylinder 18a is a cylindrical member, has an axis oriented in a vertical direction and can slidably receive the piston 18b inside. Furthermore, the outflow pipe 16b extending from the ball tap 16 is connected to the lower end of the cylinder 18a, and the flush water flowing out of the ball tap 16 flows into the cylinder 18a. Consequently, the piston 18b in the cylinder 18a is pushed up against a biasing force of the spring 18c by the water flowing into the cylinder 18a.

In addition, an outflow hole is provided in an upper end of the cylinder 18a, and a water supply pipe 32 is connected to the outflow hole. Therefore, when water flows into the cylinder 18a through the outflow pipe 16b connected to a lower part of the cylinder 18a, the piston 18b is pushed upward from the lower part of the cylinder 18a. Then, the piston 18b is pushed up to a position above the outflow hole, and the water flowing into the cylinder 18a flows out of the outflow hole to the water supply pipe 32. Furthermore, the flush water flowing into the water supply pipe 32 flows into the inner tank 14.

The rod 28 is a bar-shaped member connected to a lower surface of the piston 18b and protruding downward from inside the cylinder 18a via a through hole formed on a bottom surface of the cylinder 18a. Furthermore, the valve shaft 10a of the jet discharge valve 10 is connected to the lower end of the rod 28 via the clutch mechanism 30, and the rod 28 couples the piston 18b and the jet discharge valve 10. Consequently, when water flows into the cylinder 18a to push up the piston 18b, the rod 28 connected to the piston 18b lifts the jet discharge valve 10 upward, and the jet discharge valve 10 is opened.

Furthermore, a gap is provided between the rod 28 protruding from the bottom of the cylinder 18a and an inner wall of the through hole of the cylinder 18a, and part of the water flowing into the cylinder 18a flows out of this gap. The water flowing out of the gap flows into the inner tank 14. This gap is comparatively narrow and has a large flow channel resistance. Therefore, even if water flows out of the gap, the pressure in the cylinder 18a increases due to the water flowing through the outflow pipe 16b into the cylinder 18a, and the piston 18b is pushed up against the biasing force of the spring 18c.

Furthermore, the clutch mechanism 30 removably couples the rod 28 and the jet discharge valve 10. The clutch mechanism 30 is configured to disconnect the valve shaft 10a of the jet discharge valve 10 from the rod 28, when the jet discharge valve 10 is lifted together with the rod 28 along a predetermined distance. While the clutch mechanism 30 is disconnected, the jet discharge valve 10 is no longer linked to the movement of the piston 18b and the rod 28, and the jet discharge valve 10 descends with decrease in water level in the inner tank 14, to close the drain port 14a of the inner tank 14.

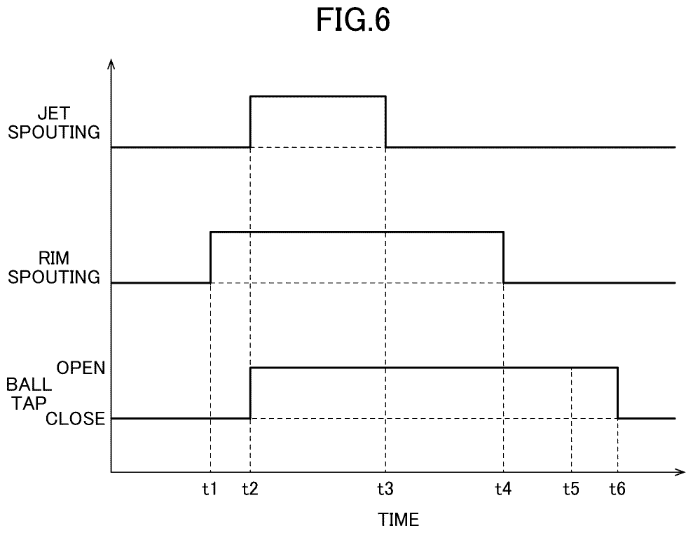

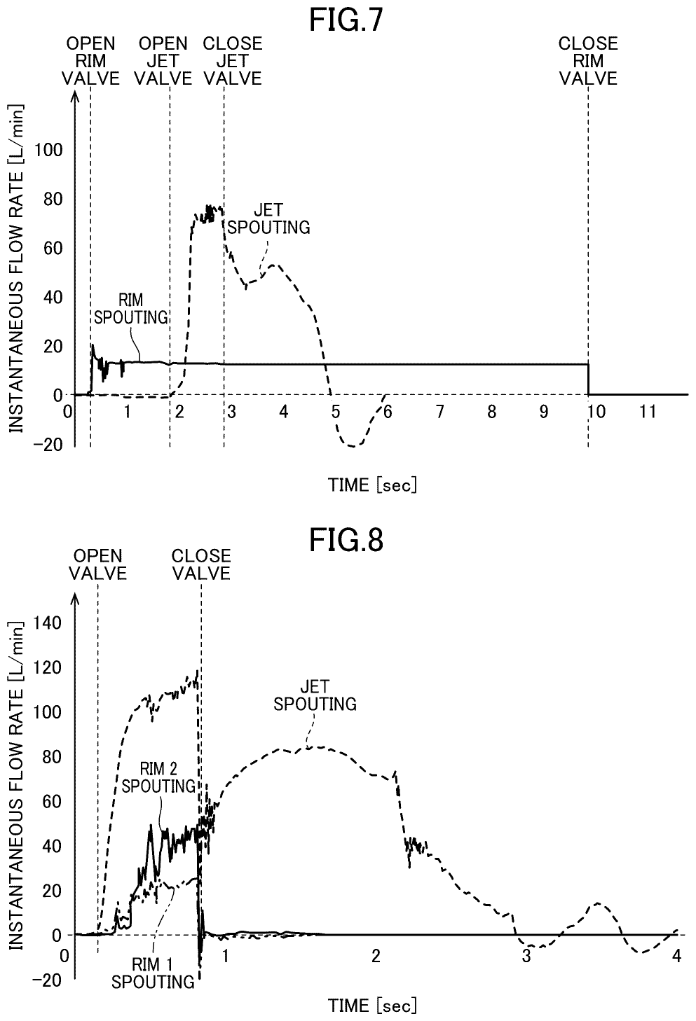

Next, newly with reference to FIGS. 6 and 7, an operation of the flush toilet apparatus 1 according to the embodiment of the present invention will be described.

FIG. 6 is a time chart showing the operation of the flush toilet apparatus 1 according to the embodiment of the present invention, and shows a state of jet spouting, a state of rim spouting, and a state of the ball tap in order from the top. FIG. 7 is a diagram showing an example of the instantaneous flow rate of flush water spouted from each of the rim spout port 2c and the jet spout port 2d in the flush toilet apparatus 1 of the present embodiment.

First, in a standby state for toilet flushing, the rim spouting drain port 4b of the flush water tank main body 4 and the drain port 14a of the inner tank 14 are closed by the rim discharge valve 8 and the jet discharge valve 10, respectively. Furthermore, in the standby state, an initial water level in the flush water tank main body 4 is higher than the predetermined water level. Consequently, the pilot valve port (not shown) of the ball tap 16 (FIG. 5) is closed, and the valve seat 20b is closed by the main valve body 20a.

Next, at time t1 in FIG. 6, when the user rotates and operates the lever handle 4a (FIG. 5) of the flush water tank main body 4 to perform toilet flushing, the bead chain 8a connected to the handle pulls up the rim discharge valve 8. Consequently, the rim discharge valve 8 is pulled away from the rim spouting drain port 4b, and the rim spouting drain port 4b is opened. When the rim spouting drain port 4b is opened, the flush water stored inside the flush water tank main body 4 (outside the inner tank 14) flows from the rim spouting drain port 4b into the rim conduit 2e (FIG. 1) and is spouted from the rim spout port 2c. By rim spouting from the rim spout port 2c, a circulating flow is formed on the waste receiving surface of the bowl 2a, and the waste receiving surface is flushed. The flush water spouted from the rim spout port 2c forms the circulating flow on an inner wall surface of the bowl 2a, and this circulating flow circulates one or more times in the bowl 2a, to completely flush the bowl 2a.

As shown in FIG. 7, in the flush toilet apparatus 1 of the present embodiment, the instantaneous flow rate of flush water spouted from the rim spout port 2c rises rapidly when the rim discharge valve 8 is opened. In such a type of flush toilet as described in Patent Literature 1 in which flush water flowing into a single water conduit is branched to be spouted, as shown in a comparative example in FIG. 8, after a discharge valve is opened, an instantaneous flow rate of flush water spouted from each rim spout port takes time to rise. This is because in the flush toilet apparatus 1 of the present embodiment, the rim spout port 2c is at the lowest position in the entire path of the rim conduit 2e from the rim spouting drain port 4b to the rim spout port 2c (FIG. 3).

In contrast, in the flush toilet apparatus of the comparative example shown in FIG. 8, flush water drained from a flush water tank flows through a water conduit toward a jet spout port, and hence the flush water reaches the rim spout port through a water conduit provided at a position lower than the rim spout port. Thus, in the flush toilet apparatus of the comparative example shown in FIG. 8, the flush water detours before reaching the rim spout port and is spouted. After the discharge valve is opened, it takes time for the instantaneous flow rate of the flush water to increase.

Next, as the flush water is drained from the rim spouting drain port 4b, the water level in the flush water tank main body 4 decreases. Consequently, the float 22 of the ball tap 16 (FIG. 5) lowers, to open the pilot valve port (not shown). This decreases the pressure in the pressure chamber 20c, to open the main valve body 20a, and flush water is supplied through the outflow pipe 16b to the hydraulic drive mechanism 18 (FIG. 5).

Then, flush water supplied to the hydraulic drive mechanism 18 and flowing into the cylinder 18a pushes up the piston 18b against the biasing force of the spring 18c. Consequently, the rod 28 coupled to the piston 18b pulls up the valve shaft 10a of the jet discharge valve 10, and the drain port 14a of the inner tank 14 is opened. That is, the jet discharge valve 10 is driven by the water supply pressure of tap water supplied via the ball tap 16 and is opened.

At time t2 in FIG. 6, the drain port 14a is opened, and the flush water stored in the inner tank 14 flows through the drain port 14a and the jet spouting drain port 4c into the jet conduit 2f (FIG. 2) and is spouted from the jet spout port 2d. The jet spout port 2d has a cross-sectional area larger than a cross-sectional area of the rim spout port 2c, and a hydraulic head pressure of the flush water in the inner tank 14 is higher than a hydraulic head pressure of the flush water in the flush water tank main body 4. Consequently, as shown in FIG. 7, an instantaneous flow rate of jet spouting is larger than an instantaneous flow rate of rim spouting.

Furthermore, by jet spouting from the jet spout port 2d, the discharge trap conduit 2b is filled with water, to induce siphon action. Due to occurrence of the siphon action, retained water and waste in the bowl 2a are suctioned into the discharge trap conduit 2b and drained to the sewage pipe (not shown). Thus, in the present embodiment, the jet discharge valve 10 is opened with elapse of a predetermined time after the rim discharge valve 8 is opened. That is, in a state in which the spouting of flush water from the rim spout port 2c is continued, the spouting of flush water from the jet spout port 2d is started, and the siphon action is activated in the discharge trap conduit 2b.

Thus, in the flush toilet apparatus 1 of the present embodiment, the siphon action can be generated in the discharge trap conduit 2b at an early stage after opening the jet discharge valve 10. In particular, the flush water initially drained from the jet spouting drain port 4c (drain port 14a) is at a high water level in the inner tank 14 and accordingly has a high hydraulic head pressure. As a result, the flush water having the high hydraulic head pressure can be effectively utilized for toilet flushing, and the instantaneous flow rate of the flush water spouted from the jet spout port 2d can be increased.

Then, the jet discharge valve 10 is pulled up to a predetermined height together with the piston 18b of the hydraulic drive mechanism 18, and the valve shaft 10a of the jet discharge valve 10 is disconnected from the rod 28 by the clutch mechanism 30 (FIG. 5). Consequently, the jet discharge valve 10 descends toward the drain port 14a as the water level in the inner tank 14 decreases. Then, at time t3 in FIG. 6, the jet discharge valve 10 is seated on the drain port 14a, and the drain port 14a is closed.

As shown in FIG. 7, by closing the jet discharge valve 10, the instantaneous flow rate of the flush water spouted from the jet spout port 2d is decreased. In FIG. 7, a reason the jet spouting continues even after the jet discharge valve 10 is closed is that the flush water remaining in the jet conduit 2f falls due to gravity and is spouted from the jet spout port 2d. Furthermore, the instantaneous flow rate of the flush water spouted from the rim spout port 2c is lower than at the start of spouting. For this reason, after the retained water and waste in the bowl 2a are drained to the discharge trap conduit 2b due to the siphon action, stop of the siphon action (siphon break) is accelerated, and the flush water can be inhibited from being excessively drained from the discharge trap conduit 2b.

Also, in the flush toilet apparatus of the comparative example shown in FIG. 8, by closing the discharge valve, the instantaneous flow rate of jet spouting is immediately decreased, and even after closing the discharge valve, the flush water remaining in the water conduit is spouted from the jet spout port. Furthermore, in the flush toilet apparatus of the comparative example shown in FIG. 8, when the discharge valve is closed, the instantaneous flow rate of water spouted from the rim spout port also decreases rapidly and is thereafter almost zero. This is because the rim spout port is at a position higher than the jet spout port, and after the discharge valve is closed, most of the flush water remaining in the water conduit flows toward the jet spout port. Thus, in the flush toilet apparatus of the comparative example shown in FIG. 8, the rim spouting is stopped almost simultaneously with the closing of the discharge valve.

At time t3 in FIG. 6, the jet discharge valve 10 is closed, and the jet spouting is stopped. Then, the siphon action in the discharge trap conduit 2b stops, and the flush water in the bowl 2a is not suctioned into the discharge trap conduit 2b. In contrast, spouting from the rim spout port 2c is continued, and rim spouting is continued even after the jet discharge valve 10 is closed. Thus, after the siphon action is stopped, the flush water spouted from the rim spout port 2c is not drained to the discharge trap conduit 2b and is therefore used to refill water reserved in the bowl 2a.

In a state in which the main valve body 20a of the ball tap 16 is opened, the flush water supplied from the water supply source 6 (water supply) is supplied to the hydraulic drive mechanism 18 via the ball tap 16 and flows into the inner tank 14 through the water supply pipe 32 (FIG. 5) connected to the cylinder 18a. Consequently, after jet spouting is stopped at time t3 in FIG. 6, the water level in the inner tank 14 is raised by the flush water inflowing from the water supply pipe 32.

In contrast, since the rim discharge valve 8 is still opened, the flush water in the flush water tank main body 4 flows out of the rim spouting drain port 4b, and the water level in the flush water tank main body 4 continues to decrease. Then, at time t4 in FIG. 6 at which the water level in the flush water tank main body 4 decreases to a predetermined dead water level, the rim discharge valve 8 is seated on the rim spouting drain port 4b, and the rim discharge valve 8 is closed. This stops rim spouting from the rim spout port 2c. Furthermore, at time t4 at which the rim spouting is stopped, a water level W in the bowl 2a returns to the water level in the standby state.

Furthermore, in the present embodiment, flush water is spouted from the rim spout port 2c by the hydraulic head pressure of the flush water in the flush water tank main body 4 continuously from opening of the rim discharge valve 8 (time t1 in FIG. 6) to closing of the valve (time t4 in FIG. 6). Consequently, the instantaneous flow rate of the flush water spouted from the rim spout port 2c decreases as the water level in the flush water tank main body 4 decreases. Therefore, the instantaneous flow rate is largest at the start of spouting and then gradually decreases. In the flush toilet apparatus 1 of the present embodiment, the instantaneous flow rate at the start of rim spouting is about 11 liters/min, and the instantaneous flow rate at the end of rim spouting is about 8 liters/min. Thus, in the flush toilet apparatus 1 of the present embodiment, rim spouting continues at an appropriate instantaneous flow rate for a long time. Furthermore, in the flush toilet apparatus 1 of the present embodiment, a total amount of flush water spouted from the rim spout port 2c and the jet spout port 2d is about 3.8 liters.

Furthermore, even after the rim discharge valve 8 is closed, the main valve body 20a of the ball tap 16 is maintained in an open state, and the flush water supplied from the water supply source 6 (water supply) therefore flows from the water supply pipe 32 into the inner tank 14 via the ball tap 16 and the hydraulic drive mechanism 18. This raises the water level in the inner tank 14. Then, at time t5 in FIG. 6 at which the inner tank 14 is full, the flush water flowing from the water supply pipe 32 into the inner tank 14 overflows to flow into the flush water tank main body 4. This begins to raise the water level in the flush water tank main body 4.

Next, the water level in the flush water tank main body 4 rises to a predetermined water level, and the float 22 of the ball tap 16 then rises, to close the pilot valve (not shown). Thus, by closing the pilot valve, the pressure in the pressure chamber 20c is increased. Then, at time t6 in FIG. 6, the main valve body 20a is pressed by the pressure in the pressure chamber 20c and seated on the valve seat 20b, to close the main valve body 20a. This stops the water supply from the water supply source 6 through the ball tap 16 to the hydraulic drive mechanism 18 to stop the supply of flush water into the inner tank 14.

By stopping the water supply to the hydraulic drive mechanism 18, the piston 18b (FIG. 5) in the cylinder 18a pushed up by the supplied water is pushed down due to the biasing force of the spring 18c. Accordingly, the rod 28 attached to the piston 18b also lowers. Then, the rod 28 lowers to a predetermined position, and the clutch mechanism 30 recouples the rod 28 to the valve shaft 10a of the jet discharge valve 10. As described above, once toilet flushing ends, the flush toilet apparatus 1 returns to the standby state for the toilet flushing.

According to the flush toilet apparatus 1 of the embodiment of the present invention, the flush water in the flush water tank main body 4 is spouted from the rim spout port 2c via the rim discharge valve 8 and the rim conduit 2e, and the flush water is spouted from the jet spout port 2d via the jet discharge valve 10 and the jet conduit 2f. Consequently, an amount of flush water spouted from the rim spout port 2c and an amount of flush water spouted from the jet spout port 2d can be independently controlled, and the amount of rim spouting can be sufficiently secured. Thus, the bowl 2a can be sufficiently flushed. Furthermore, the cross-sectional area of the rim spout port 2c is smaller than the cross-sectional area of the jet spout port 2d. Therefore, even if spouting time from the rim spout port 2c is sufficiently secured, an amount of flush water for use does not increase significantly, and water saving can be achieved.

According to the flush toilet apparatus 1 of the present embodiment, the rim conduit 2e is configured so that the rim spout port 2c is at the lowest position in the path from the rim discharge valve 8 to the rim spout port 2c (FIG. 3). Therefore, the flush water drained via the rim discharge valve 8 is spouted from the rim spout port 2c without detouring. As a result, the instantaneous flow rate of the flush water spouted from the rim spout port 2c rises in a short time, and a sufficient flushing effect can be obtained even if the spouting time is reduced.

According to the flush toilet apparatus 1 of the present embodiment, the jet discharge valve 10 is opened with the elapse of the predetermined time after the rim discharge valve 8 is opened (time t2 in FIG. 6). Therefore, after flushing the bowl 2a by rim spouting, siphon action is activated by jet spouting, and hence flush water can be efficiently distributed to flush a bowl surface and to discharge waste. In addition, since the spouting of flush water from the rim spout port 2c is continued even after the jet discharge valve 10 is closed (time t3 to t4 in FIG. 6), water spouted from the rim spout port 2c can be utilized to refill the bowl 2a.

According to the flush toilet apparatus 1 of the present embodiment, the instantaneous flow rate of the flush water spouted from the rim spout port 2c is largest at the start of the spouting and then gradually decreases (FIG. 7), and hence the instantaneous flow rate of the flush water from the rim spout port 2c decreases after the siphon action is activated by the jet spouting. Consequently, siphon break after waste is drained by the siphon action is accelerated, and wasteful drain of the flush water into the discharge trap conduit 2b can be suppressed. Thus, the flush water can be efficiently utilized.

Furthermore, according to the flush toilet apparatus 1 of the present embodiment, since the flush toilet main body 2 includes one rim spout port 2c, the total cross-sectional area of the rim spout port 2c can be easily set small, and the spouting time of flush water from the rim spout port 2c can be extended while reducing an amount of flush water for use.

According to the flush toilet apparatus 1 of the present embodiment, the rim discharge valve 8 is located outside the jet discharge valve 10 in the width direction of the flush toilet main body 2, and the rim conduit 2e, extends to the rim spout port 2c, through outside the seat hole 2g provided on the upper surface of the flush toilet main body 2 in the width direction of the flush toilet main body 2 (FIG. 1). As a result, while securing a sufficient space for the jet conduit 2f in the flush toilet main body 2, the rim conduit 2e that communicates between the rim discharge valve 8 and the rim spout port 2c can be formed short, and rim spouting can be started at an early stage.

As above, the flush toilet apparatus of the embodiment of the present invention has been described, and various changes can be made to the above-described embodiment. In the above-described embodiment, the jet discharge valve 10 is opened using the hydraulic drive mechanism 18 to open the jet discharge valve 10 after the rim discharge valve 8 is opened. As a modification, the rim discharge valve 8 and/or the jet discharge valve 10 may be configured to open using power of a motor (not shown), and the motor may be operated to open the jet discharge valve 10 with delay. Alternatively, in the present invention, the rim discharge valve 8 and the jet discharge valve 10 may be configured to be pulled up by a bead chain or the like connected to the lever handle 4a, and the bead chain or the like attached to the jet discharge valve 10 may be lengthened so that the jet discharge valve 10 is opened after the rim discharge valve 8 is opened.

### REFERENCE SIGNS LIST

1 flush toilet apparatus
2 flush toilet main body
2a bowl
2b discharge trap conduit
2c rim spout port
2d jet spout port
2e rim conduit
2f jet conduit
2g seat hole
4 flush water tank main body
4a lever handle
4b rim spouting drain port
4c jet spouting drain port
6 water supply source
8 rim discharge valve
8a bead chain
10 jet discharge valve
10a valve shaft
14 inner tank
14a drain port
14b drain port forming member
15 overflow pipe (exhaust path)
16 ball tap (water supply valve)
16a inflow pipe
16b outflow pipe
18 hydraulic drive mechanism
18a cylinder
18b piston
18 spring
20 main valve body
20b valve seat
20c pressure chamber
22 float
24 arm
28 rod
30 clutch mechanism
32 water supply pipe

1. A flush toilet apparatus that flushes with flush water stored in a flush water tank, comprising:
a flush toilet main body including a bowl and a discharge trap conduit extending from a lower part of the bowl,
a flush water tank main body that stores flush water for flushing the bowl of the flush toilet main body,
a rim discharge valve provided in the flush water tank main body, to control spouting and stop of flush water from one or more rim spout ports provided in the flush toilet main body,
a jet discharge valve provided in the flush water tank main body, to control spouting and stop of flush water from a jet spout port provided in the flush toilet main body,
a rim conduit provided in the flush toilet main body, to guide flush water drained via the rim discharge valve to the one or more rim spout ports, and
a jet water conduit provided in the flush toilet main body, to guide flush water drained via the jet discharge valve to the jet spout port,
wherein a sum of cross-sectional areas of the one or more rim spout ports is smaller than a cross-sectional area of the jet spout port.

2. The flush toilet apparatus according to claim 1, wherein the rim conduit is configured so that the one or more rim spout ports are each at the lowest position in a path from the rim discharge valve to the one or more rim spout ports.

3. The flush toilet apparatus according to claim 1, wherein the jet discharge valve is opened with elapse of a predetermined time after the rim discharge valve is opened, and the spouting of flush water from the one or more rim spout ports is continued even after the jet discharge valve is closed.

4. The flush toilet apparatus according to claim 3, wherein an instantaneous flow rate of the flush water spouted from the one or more rim spout ports is largest at start of spouting and then gradually decreases.

5. The flush toilet apparatus according to claim 1, wherein the flush toilet main body includes single rim spout port.

6. The flush toilet apparatus according to claim 5, wherein the rim discharge valve is located outside the jet discharge valve in a width direction of the flush toilet main body, and the rim conduit extends, to the rim spout port, through outside a seat hole provided on an upper surface of the flush toilet main body in the width direction of the flush toilet main body.
